(19) United States
(12) Patent Application Publication
(10) Pub. No.: US 2026/0009810 A1
(43) Pub. Date: Jan. 8, 2026

(54) REAL-TIME CUVETTE MONITORING

(71) Applicant: BECKMAN COULTER, INC., Brea, CA (US)

(72) Inventors: Takayuki MIZUTANI, Edina, MN (US); Masayuki OSAKO, Shizuoka (JP); Shinya MATSUYAMA, Shizuoka (JP)

(21) Appl. No.: 19/133,686

(22) PCT Filed: Nov. 21, 2023
(86) PCT No.: PCT/US2023/080732

§ 371 Date: May 28, 2025

Related U.S. Application Data
(60) Provisional application No. 63/428,497, filed on Nov. 29, 2022.

(51) Int. Cl. G01N 35/00; G01N 21/15; G01N 21/84; G01N 35/02; G01N 35/10

(52) U.S. Cl. CPC G01N 35/00663; G01N 21/15; G01N 21/84; G01N 35/025; G01N 35/1016; G01N 2021/157

(57) ABSTRACT

A method of using an automatic chemical analyzer includes detecting in real-time abnormalities in a cuvette used with the analyzer and further detecting abnormal reaction conditions present in the cuvette used with the analyzer. Baseline signals are continuously updated and compared with subsequent signal recordings, as well as evaluating data within a given subsequent signal recording itself. Signal criteria are used when evaluating and comparing signal recording data and the analyzer will indicate or provide an alert where a detected abnormality in the cuvette or reaction condition is identified.

### BACKGROUND

Certain automatic analyzers are used to analyze samples, such as biological samples like blood or urine. These analyzers are able to measure a quantity of light transmitted through a reaction container having a sample and a reagent within the container. With such analyzers, the reaction container is located between a light source and a spectroscopic detector.

While a variety of automatic analyzers for measuring an analyte in a sample and methods of use have been made and used, it is believed that no one prior to the inventor(s) has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 illustrates an exemplary configuration of an analyzer.

FIG. 2 is a schematic view illustrating a diagrammatic configuration of a photometry section of the analyzer of FIG. 1.

FIG. 3 is a perspective view of an exemplary reaction container or cuvette.

FIG. 4 depicts a method of using the analyzer of FIG. 1.

FIG. 5 depicts a process for detecting abnormalities and abnormal reaction conditions in a cuvette.

FIG. 6 depicts a process for defining a signal recording range according to the process of FIG. 5.

FIG. 7 depicts an exemplary output showing voltage curves for a cuvette and an exemplary defined signal recording range.

FIG. 8 depicts a process for defining a first baseline signal according to the process of FIG. 5.

FIG. 9 depicts a process for evaluating cuvette integrity according to the process of FIG. 5.

FIG. 10 depicts an exemplary voltage curve showing the detection of missing cuvettes.

FIG. 11 depicts a process for defining a first reagent blank signal according to the process of FIG. 5.

FIG. 12 depicts a process for detecting an abnormal reaction condition according to the process of FIG. 5.

FIG. 13 depicts a signal recording showing detection of an abnormal reaction condition.

FIG. 14 depicts an exemplary table showing a matrix of signal recording data from a plurality of signal recordings for a given cuvette.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

With automatic analyzers that detect and/or measure an analyte in a sample using spectrophotometry, the detection and/or measurement can be impacted by (1) the quality or integrity of the reaction container, e.g., a cuvette, and (2) the quality or conditions of the reaction occurring within the cuvette. For instance, the detection and/or measurement can be impacted by a cuvette having a scar or stain. Also, the detection and/or measurement can be impacted by a reaction that produces crystallization or bubbles. The paragraphs that follow describe a method and apparatus that detects abnormalities in the cuvette as well as abnormal reaction conditions in real-time while being able to distinguish detected abnormal reaction conditions from abnormalities in the cuvette quality or integrity. The methods and apparatuses described herein help users know what corrective action to take without taking unnecessary steps that take equipment off-line. For instance, if bubbles are detected in the reaction, then it might be unnecessary to take an analyzer off-line to do an enhanced cuvette cleaning.

### I. Exemplary Analyzer Configuration

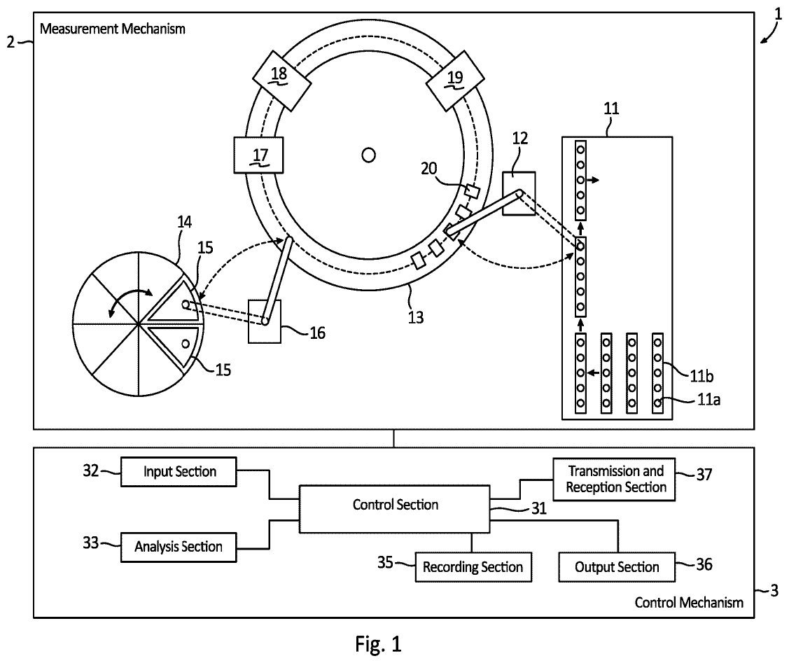

FIG. 1 illustrates an exemplary analyzer 1. The analyzer 1 comprises a measurement mechanism 2 for measuring absorbance of a liquid contained in a reaction container 20, also referred to herein as a cuvette 20. The analyzer 1 also comprises a control mechanism 3 for controlling the analyzer 1 including analyzing a measurement result in the measurement mechanism 2.

With the measurement unit 2, there is a sample transferring section 11 including one or more sample racks 11b each retaining one or more sample containers 11a. Each sample container 11a contains a sample such as blood or urine. There is a sample dispensing unit 12 for dispensing the sample into one or more of the cuvettes 20. A reaction table 13 retains the cuvettes 20 along the circumference, and the reaction table 13 is rotatable to transfer the cuvettes 20 to predetermined positions. A reagent repository 14 houses one or more reagent containers 15 in which a reagent is contained. A reagent dispensing unit 16 dispenses the reagent into the cuvettes 20. There is further a stirring section 17 for stirring the sample and the reagent in the cuvettes 20. A photometry section 18 is configured to measure the absorbance of a liquid contained in the cuvettes 20. Also, a washing section 19 exists for washing the cuvettes 20 to prepare them for a subsequent test or analysis.

The control mechanism 3 comprises a control section 31, an input section 32, an analysis section 33, a recording section 35, an output section 36, and a transmission and reception section 37. The input section 32, analysis section 33, recording section 35, output section 36 and transmission and reception section 37 are electrically connected with the control section 31.

In some versions the control section 31 is realized with a CPU and the like, and the control section 31 controls the processing and operation of respective sections of the analyzer 1. The control section 31 performs processing on information input from respective sections of the analyzer 1, and also outputs the processed information to the respective sections.

In some versions the input section 32 is realized with a keyboard, a mouse, a touch panel with input and output functions, and the like, and acquires various kinds of information necessary for a sample analysis, instruction information for an analysis operation, and the like.

The analysis section 33 performs a component analysis of a sample, and the like, based on a measurement result of absorbance measured by the photometry section 18.

In some versions, the recording section 35 is realized with a hard disk for magnetically storing information, and a memory for loading, and electrically storing, various programs from the hard disk when the analyzer 1 performs processing. The recording section 35 stores various pieces of information including an analysis result of a sample and the like. The recording section 35 may comprise a supplemental storing apparatus capable of reading information stored on a storage medium, such as a flash drive, SD card, and the like. Additionally, the analyzer 1 can be network connected such that network or cloud drives may be used as a storage medium.

In some versions, the output section 36 is realized with a display, a printer, a speaker and the like, for outputting various kinds of information.

The transmission and reception section 37 has a function as an interface for transmitting and receiving information in accordance with a predetermined format via a communication network (not shown).

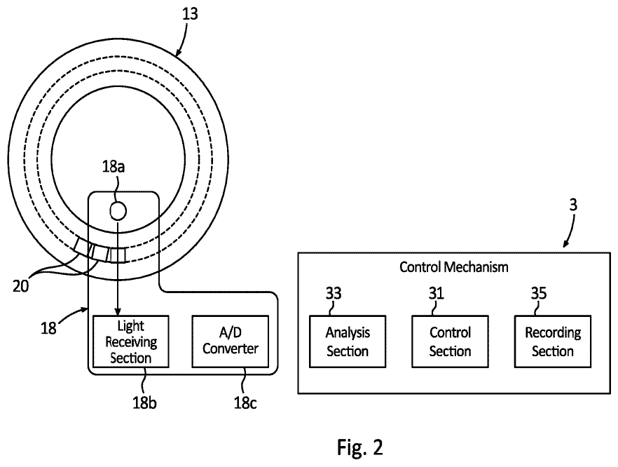

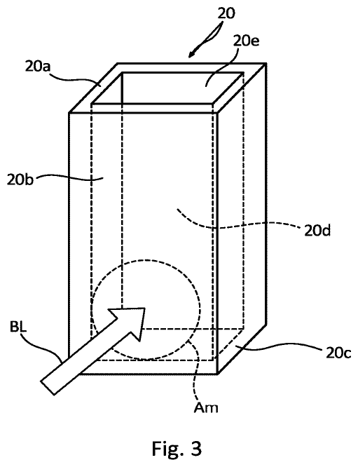

FIG. 2 is a schematic view illustrating a diagrammatic configuration of the photometry section 18, and FIG. 3 is a perspective view of a cuvette 20. As illustrated in FIG. 2, the photometry section 18 comprises a light source 18a, a light receiving section 18b, and an A/D converter 18c. The light source 18a and light receiving section 18b are positioned facing each other with a cuvette 20 retained by the reaction table 13 positioned therebetween. The light source 18a is realized with a halogen lamp or the like and irradiates light for analysis onto the cuvette 20. The light receiving section 18b comprises a diffraction grating, such as a concave surface diffraction grating, and also comprises a light receiving sensor, such as a light receiving element array, a CCD sensor, a CMOS sensor, or the like for measuring light separated by the diffraction grating for each spectrum determined by a measurement category. The light receiving section 18b outputs a signal corresponding to the amount of light measured for each spectrum. The A/D converter 18c converts the signal output from the light receiving section 18b into a digital value, and outputs the digital value to the control section 31. In one version, the signal output is a voltage.

As illustrated in FIG. 3, the cuvette 20 includes a liquid retaining part 20d for retaining a liquid. The liquid retaining part 20d is defined by the side walls, a bottom wall 20c, and an opening 20e. For the cuvette 20, a transparent material, such as glass including heat-resistant glass, or synthetic resin including cyclic olefin and polystyrene, is used to transmit light contained in an analysis light BL (e.g., analysis light of a wavelength in the range of 340 nanometers to 800 nanometers) irradiated from the light source 18a of the photometry section 18. In one example, when the cuvette 20 passes, with the rotation of the reaction table 13, through the analysis light BL the bottom portion of the side wall 20b is used as a photometric region Am, through which the analysis light BL passes. The shape of the cuvette 20 can be in such a manner not to cause variation in the measurement of absorbance at a plurality of points of the cuvette 20. The shape need not be in a cuboid shape as illustrated in FIG. 3.

### II. Exemplary Analyzer Method of Use

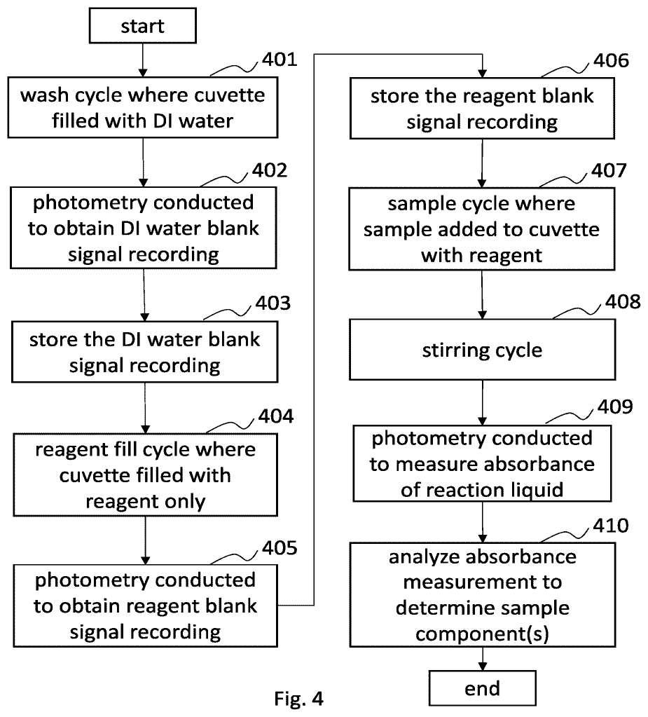

FIG. 4 illustrates an exemplary method of using the analyzer 1. In the analyzer 1, during a washing cycle or step 401 each cuvette 20 is filled with deionized water. In a photometry step 402, the photometry section 18 measures absorbance of the cuvettes 20, with each cuvette 20 containing deionized water. The output of this measurement is a signal recording for each cuvette 20, which is represented by a plot of voltage along time or distance. In some instances, these signal recordings may be referred to or consider DI water blank signal recordings. In a storing step 403, the signal recording is stored.

After the cuvettes 20 are emptied of the deionized water, there is a reagent fill cycle or step 404 where each cuvette 20 is filled with reagent from the reagent container 15. In another photometry step 405, the photometry section 18 measures absorbance of the cuvettes 20, with each cuvette 20 containing only reagent. The output of this measurement is another signal recording for each cuvette 20, which is again represented by a plot of voltage along time or distance. In some instances, these signal recordings may be referred to or consider reagent blank signal recordings. In another storing step 406, the signal recording is stored.

Next, in a sample cycle step 407, the sample dispensing unit 12 dispenses a sample from a sample container 11a into the cuvettes 20 that contain the reagent. In a stirring step 408, the contents of the cuvettes 20 may be stirred by the stirring section 17. Then, in another photometry step 409, the photometry section 18 measures absorbance of a reaction liquid obtained through reaction of the reagent and the sample. In a component analysis step 410, the analysis section 33 conducts an analysis based on these measurement results, thereby conducting a component analysis of a sample or the like automatically. Thereafter, the process repeats with the washing section 19 washing the cuvettes 20 after the measurement of the reaction liquid by the photometry section 18 is completed. Accordingly, the same cuvette 20 can be used in the analyzer 1 numerous times, and over time the analyzer 1 will accumulate multiple water blank signal recordings and multiple reagent blank signal recordings for each cuvette 20.

### III. Exemplary Cuvette Monitoring for Quality

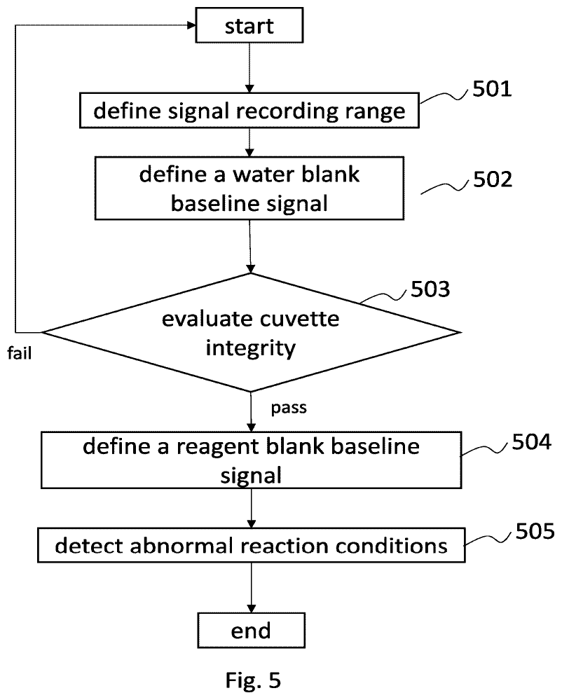

FIG. 5 illustrates an exemplary process for evaluating cuvette integrity and for detecting abnormal reaction conditions in an automatic analyzer such as analyzer 1 or another comparable analyzer. A first step 501 involves defining a signal recording range to be used when recording signals. A subsequent step 502 involves defining a water blank baseline signal for each cuvette, sometimes herein referred to as a first baseline signal. Another subsequent step 503 involves evaluating the cuvette 20 integrity or quality. If the cuvette 20 quality evaluation fails, the test would not continue, and corrective action would be taken and the test then started again. If the cuvette 20 quality evaluation succeeds or passes, then step 504 involves defining a reagent blank baseline signal for each cuvette 20, sometimes herein referred to as a second baseline signal. And another subsequent step 505 involves detecting abnormal reaction conditions. These steps will be described in greater detail in the following paragraphs and with respect to additional figures.

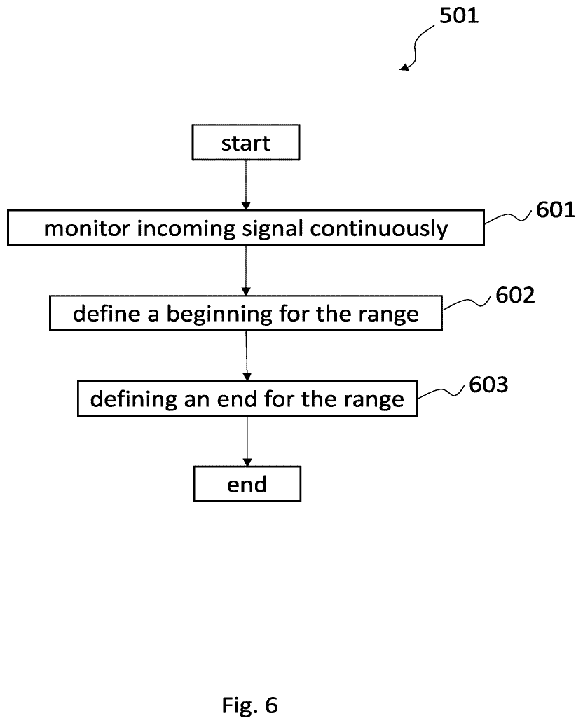

FIG. 6 illustrates an exemplary method of the step 501 of defining a signal recording range as indicated in FIG. 5. With the analyzer 1, the light receiving section 18b, also sometimes referred to as the detector, continuously receives signals across a width of the cuvettes 20, as well as between the cuvettes 20. In one example, the internal width of the cuvettes 20 is 4 millimeters. When defining the signal recording range, a step 601 involves monitoring the incoming signal continuously. In the present example the monitored signal represents a voltage output that is derived from a light intensity detected by the photometry section 18 of the analyzer 1. The photometry section 18 may also be referred to herein as a spectrophotometer. In some versions, the voltage output may be a negative voltage value.

When defining the signal recording range, a subsequent step 602 involves defining a beginning or starting point for the range. In the present example, this is done by identifying a predetermined starting point. In one version, the beginning point in time is 1 millisecond after the incoming signal goes below −1.0 volts. In view of the teachings herein, those of ordinary skill in the art will understand that other beginnings or starting points may be used and defined based on the incoming signal achieving another level of voltage.

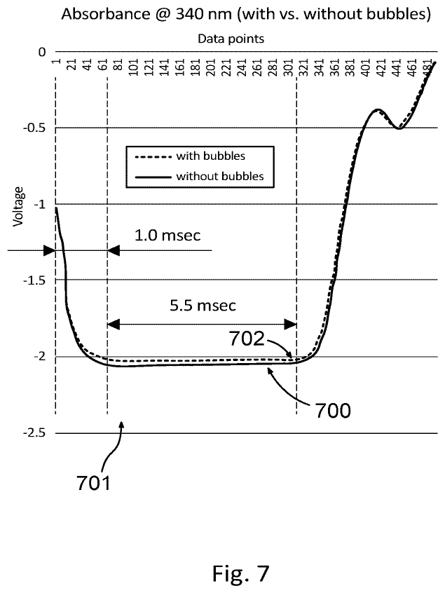

With the beginning of the signal recording range defined, another step 603 involves defining an end for the range. In the present example, this is done by identifying a predetermined end point. In one version, the end point in time is 5.5 milliseconds after the beginning point. In the present example, based on the rotation speed of the reaction table 13, the distance encompassed by the defined signal recording range spans 3.6 millimeters of the 4 millimeter internal width of the cuvette 20. FIG. 7 illustrates an example of signal recordings 700, 702 showing a defined signal recording range 701.

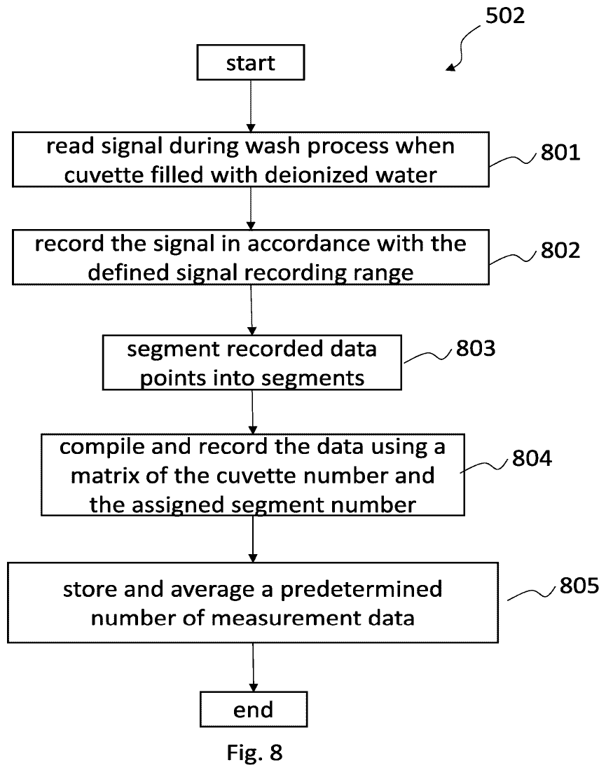

FIG. 8 illustrates an exemplary method of the step 502 of defining a water blank baseline signal as indicated in FIG. 5. As mentioned above, during a wash process or cycle within the analyzer 1, the cuvettes 20 are filled with deionized water for a period of time. During this time, the reaction table 13 rotates the cuvettes 20 through the photometry section 18. A signal reading step 801 involves reading the signal of each cuvette 20—in the present example at 340 nanometers—when these cuvettes 20 contain the deionized water. In view of the teachings herein, those of ordinary skill in the art will understand that other wavelengths may be used when reading the signal. A recording step 802 involves recording the signal from the reading step 801 in accordance with the defined signal recording range 501 for the multiple cuvettes 20.

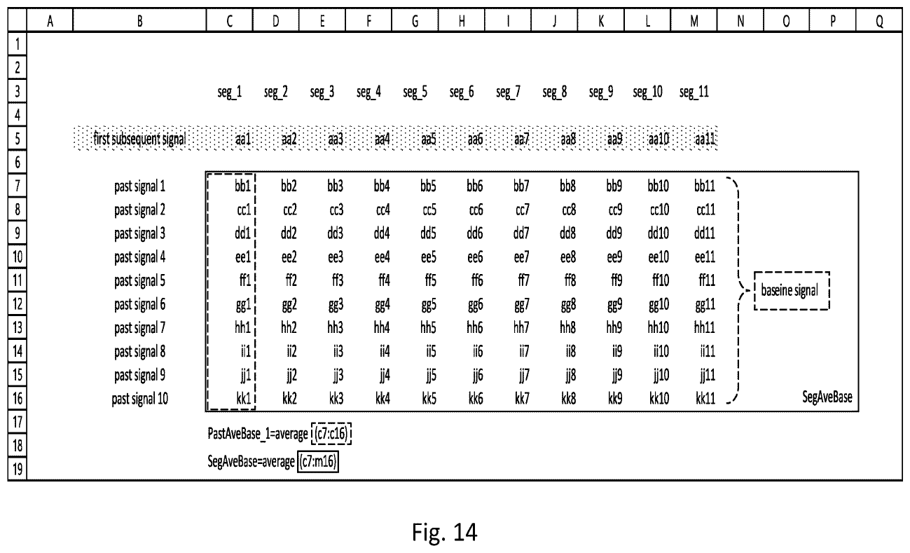

A segmenting step 803 involves segmenting the recorded data points into multiple segments for each cuvette 20 where data was recorded according to the recording step 802. By way of example and not limitation, in the present example for one cuvette 20, 275 data points are collected during the recording step 802 (i.e., one data point every 0.02 millisecond) and those are segmented into 11 segments or sections across the signal recording range for the cuvette 20. In other words, the signal recording range 701 defined above and shown, for example, in FIG. 7 would be segmented into 11 segments with each segment containing multiple data points. With data recorded for multiple cuvettes 20, a compiling and recording step 804 involves grouping the segmented data in a matrix such that the data is grouped and recorded by cuvette number and segment number. For instance, all the data from the first defined segment of each cuvette would be recorded, and all the data from the second defined segment of each cuvette would be recorded, and so forth. FIG. 14 depicts an exemplary matrix of abstract data recorded by segment for a given cuvette during multiple cycles, such as multiple wash cycles for example.

After the compiling and recording step 804, a storing and averaging step 805 involves storing a predetermined number of measurement data for a given cuvette 20 from the cuvette wash cycle. By way of example only, in the present example the most recent 10 measurement data from each cuvette 20 analyzed during the wash cycle is stored. In this manner, the water blank baseline signal for each cuvette 20 is continuously updated as the analyzer 1 continues to analyze the cuvettes 20. The storing and averaging step 805 involves averaging the data for each cuvette 20 from the stored predetermined number of measurement data from the cuvette wash cycle and storing this average as a water blank baseline signal for each of the cuvettes 20. By way of example, the signal recording 700 shown in FIG. 7 can be representative of the output of a type of baseline signal for a given cuvette 20.

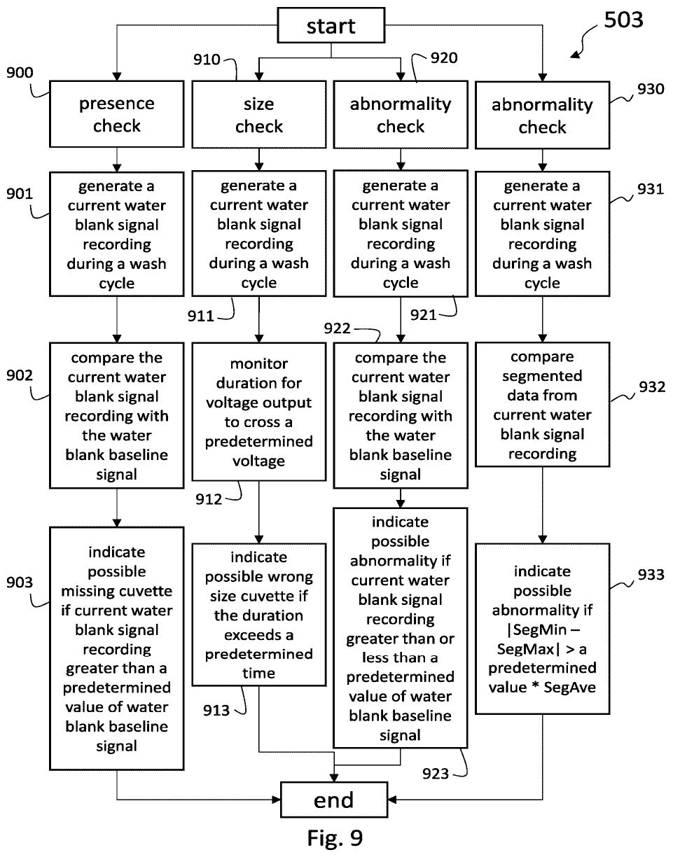

FIG. 9 illustrates an exemplary method of the step 503 of evaluating cuvette 20 integrity or quality as indicated in FIG. 5. As shown in FIG. 9, there are multiple integrity or quality checks that can be performed. These include checking to verify a cuvette is present, checking to verify a present cuvette is the correct size, checking for a stained cuvette, and/or checking for a cuvette having a scar.

In a presence check 900, a subsequent or current water blank signal recording is taken and compared to a previously generated water blank baseline signal. For instance, in one example the analyzer 1 has already analyzed each cuvette 20 in the analyzer 1 more than ten times. As described above, the most recent 10 measurement data here are averaged and saved as the water blank baseline signal for the respective cuvette 20. In a subsequent step 901 during the next wash cycle, the photometry section 18 again measures, and the analyzer 1 generates a current water blank signal recording for each cuvette 20. In a comparing step 902, the current water blank signal recording for the given cuvette 20 is compared to the previously generated water blank baseline signal for that cuvette 20. In an analysis step 903, where the difference in these signals is greater than a predetermined value, then the analyzer 1 will indicate to the user a fail status and can further indicate to the user that a cuvette 20 may be missing. In one example, if the current water blank signal recording is greater than 10% of the water blank baseline signal, then the analyzer 1 will present a fail status and notification of a possible missing cuvette. A user at this point would be prompted to check for a missing cuvette before further analysis of samples continues.

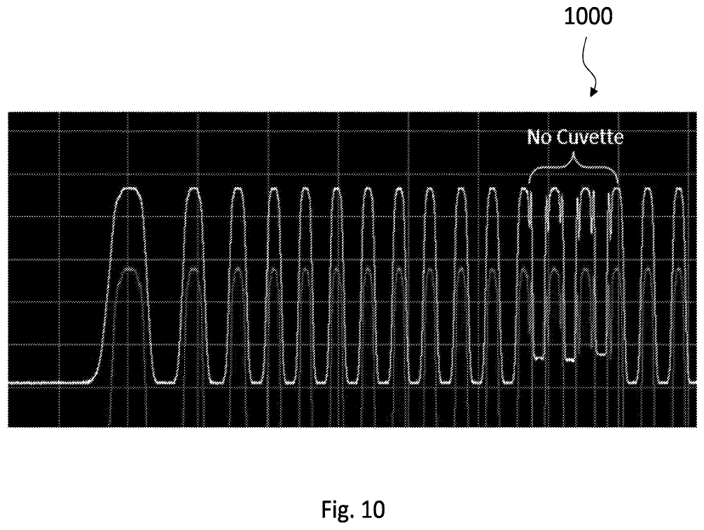

FIG. 10 illustrates an example of a signal recording 1000 showing an instance with a detected missing cuvette, in this illustrated example, three missing cuvettes are shown.

Referring again to FIG. 9, in a size check 910, a step 911 involves generating a subsequent or current water blank signal recording like mentioned above. In this process, a monitoring step 912 checks the time for the voltage output to cross a predetermined voltage. In a comparing step 913, the time it takes for the current water blank signal recording to cross the predetermined voltage is compared to a predetermined time. Where the time to cross the predetermined voltages exceeds the predetermined time, then the analyzer 1 will indicate to the user a fail status and can further indicate to the user that a cuvette 20 may be the wrong size. In one example, if the current water blank signal recording takes longer than 8 milliseconds to cross a −1.0 voltage then then the analyzer 1 will present a fail status and notification of a possible wrong size cuvette. A user at this point would be prompted to check for a wrong size cuvette before further analysis of samples continues.

In an abnormality check 920, a subsequent or current water blank signal recording is taken and compared to a previously generated water blank baseline signal. For instance, where the analyzer 1 has already analyzed each cuvette 20 in the analyzer 1 more than ten times. As described above, the most recent 10 measurement data here are averaged and saved as the water blank baseline signal for the respective cuvette 20. In a subsequent step 921 during the next wash cycle, the photometry section 18 again measures, and the analyzer 1 generates a current water blank signal recording for each cuvette 20. In a comparing step 922, the current water blank signal recording for the given cuvette 20 is compared to the previously generated water blank baseline signal for that cuvette 20. In an analysis step 923, where the difference in these signals is greater than or less than a predetermined value, then the analyzer 1 will indicate to the user a fail status and can further indicate to the user that a cuvette 20 may contain an abnormality. In one example, if the current water blank signal recording is greater than or less than 2% of the water blank baseline signal, then the analyzer 1 will present a fail status and notification of a possible abnormality in the cuvette 20. In one example, the abnormality detected in this manner may comprise a stain on the surface of the cuvette 20. A user at this point would be prompted to check the cuvette before further analysis of samples continues. In some versions the test may be skipped, and an enhanced wash conducted before resuming.

In another abnormality check 930, a step 931 involves generating a subsequent or current water blank signal recording for each cuvette similar to the process of the above-mentioned abnormality check 920. In a comparing step 932, data from the current water blank signal recording for the given cuvette 20 is segmented into a predetermined number of segments, and then the averages of the segmented data sets are used to detect an abnormality in the cuvette 20. For instance, in an analysis step 933, the absolute value of the difference in the segment having the minimum average (SegMin) and the segment having the maximum average (SegMax) is determined. This determined value is then compared to the average of all the segments (SegAvg). The following equation is representative, where PV represents the predetermined value:

$$\vert SegMax - SegMax \vert > PV * SegAvg .$$

Where the absolute value of the difference in SegMin and SegMax exceeds a predetermined value of SegAvg, then the analyzer 1 will indicate to the user a fail status and can further indicate to the user that a cuvette 20 may contain an abnormality. In one example, the predetermined value is 5% such that if the absolute value of the difference in SegMin and SegMax exceeds 5% of SegAvg, then the analyzer 1 will present a fail status and notification of a possible abnormality in the cuvette 20. In one example, the abnormality detected in this manner may comprise a scar on the surface of the cuvette 20. A user at this point would be prompted to check the cuvette before further analysis of samples continues. In some versions the test may be skipped, and an enhanced wash conducted before resuming.

### IV. Exemplary Cuvette Monitoring for Reaction Conditions

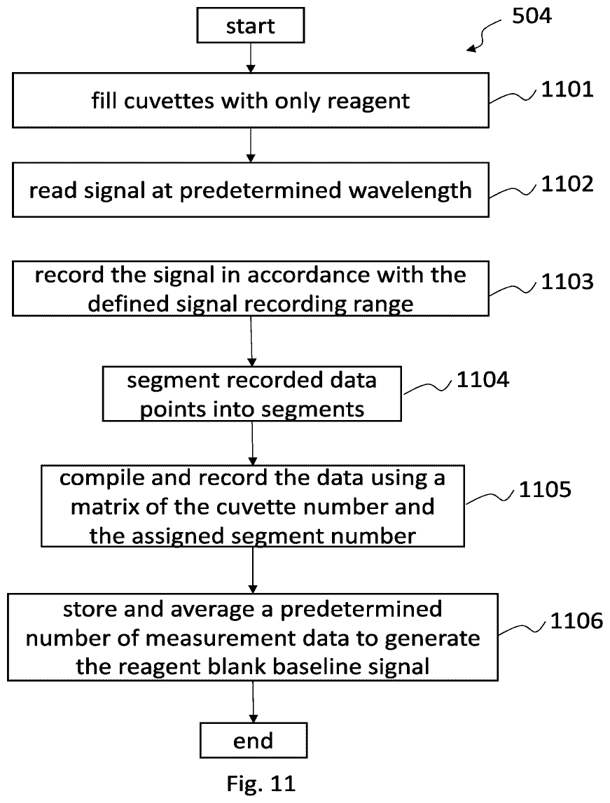

FIG. 11 illustrates an exemplary method of the step 504 of defining a reagent blank baseline signal as indicated in FIG. 5. During the method of step 504, a reagent fill step 1101 involves filling the cuvettes 20 with only the reagent from the reagent container 15. At this point no sample from sampling containers 11a is included or dispensed into the cuvettes 20. The reaction table 13 rotates the cuvettes 20 through the photometry section 18 after filling so an absorbance measurement is made as described above. A signal reading step 1102 involves reading the signal from the photometry output—in the present example at 340 nanometers—when the cuvettes 20 contain reagent only. A recording step 1103 involves recording the signal from the reading step 1102 in accordance with the defined signal recording range 501 to generate a reagent blank signal recording for each cuvette 20.

A segmenting step 1004 involves segmenting the recorded data points into multiple segments for each cuvette 20 where data was recorded according to the recording step 1103. By way of example and not limitation, in the present example for one cuvette 20, 275 data points are collected during the recording step 1103 (i.e., one data point every 0.02 millisecond) and those are segmented into 11 segments or sections across the signal recording range for the cuvette 20. With data recorded for multiple cuvettes 20, a compiling and recording step 1105 involves grouping the segmented data in a matrix such that the data is grouped and recorded by cuvette number and segment number. For instance, all the data from the first defined segment of each cuvette would be recorded, and all the data from the second defined segment of each cuvette would be recorded, and so forth.

After the compiling and recording step 1105, a storing and averaging step 1106 involves storing a predetermined number of the collected measurement data. By way of example only, in the present example the last 100 measurement data from the reagent only filled cuvettes is stored for each cuvette 20. The storing and averaging step 1106 also involves averaging the data from the stored predetermined number of measurement data for each cuvette 20 and storing this average as a baseline for each cuvette 20, which represents that cuvette's reagent blank baseline signal. By way of example and not limitation, in the present example the data across 11 segments from the most recent 100 measurements for each cuvette 20 is averaged and this average is stored as the reagent blank baseline signal for the given cuvette 20. Furthermore, as the analyzer 1 continues analyzing and generating new reagent blank signal recordings for each cuvette 20, this average representing the reagent blank baseline signal is continuously updated based on the most recent measurements.

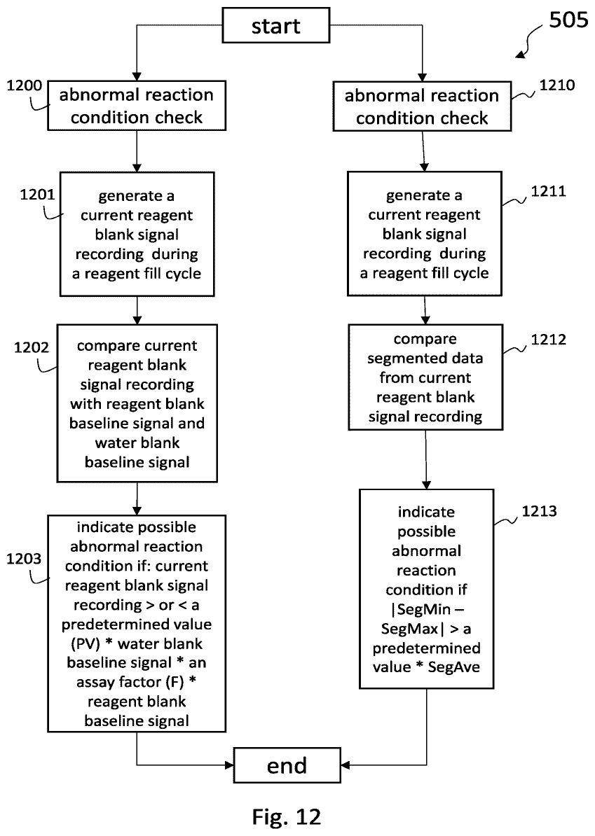

FIG. 12 illustrates an exemplary method of the step 505 of detecting abnormal reaction conditions within a cuvette 20 as indicated in FIG. 5. As shown in FIG. 12, an abnormal reaction condition check 1200 includes a step 1201 where a subsequent or current reagent blank signal recording is generated for a cuvette 20 containing reagent only. A step 1202 involves comparing the current reagent blank signal recording with the reagent blank baseline signal and the water blank baseline signal.

A step 1203 involves indicating a possible abnormal reaction condition if the current reagent blank signal recording is greater than or less than a predetermined value multiplied by the water blank baseline signal multiplied by an assay factor multiplied by the reagent blank baseline signal. This can be represented by the following two equations:

$$NewRgtBlank > PV * WtrBlankBaseSig * F * RgtBlankBaseSig , and \qquad ( 1 )$$

$$NewRgtBlank < PV * WtrBlankBaseSig * F * RgtBlankBaseSig . \qquad ( 2 )$$

NewRgtBlank represents the subsequent or current reagent blank signal recording.
PV represents the predetermined value.
WtrBlankBaseSig represents the water blank baseline signal.
F represents an assay factor specific to a given reagent.
RgtBlankBaseSig represents the reagent blank baseline signal.

By way of example and not limitation, in one version the predetermined value PV is 2%. When an abnormal reaction condition is detected in this manner, the analyzer 1 will present a fail status and notification of a possible abnormal reaction condition in the cuvette 20. In one example, the abnormal reaction condition detected in this manner may comprise bubbles or crystals formed or forming in the cuvette 20. A user at this point would be prompted to check the cuvette before further analysis of samples continues. In some versions the test may be skipped, and an enhanced wash conducted before resuming, or the test may be skipped and the cuvette 20 proceeds to the wash cycle for the next test.

FIG. 12 also depicts another abnormal reaction condition check 1210 that includes a step 1211 where a current reagent blank signal recording is generated for a cuvette 20 containing reagent only. A step 1212 involves segmenting data from the current reagent blank signal recording for a given cuvette 20 into a predetermined number of segments, and then the averages of the segmented data sets are used to detect an abnormal reaction condition in the cuvette 20. For instance, a step 1233 involves calculating the absolute value of the difference in the segment having the minimum average (SegMin) and the segment having the maximum average (SegMax). This determined or calculated value is then compared to the average of all the segments (SegAvg) for the current reagent blank signal recording. The following equation is representative, where PV represents the predetermined value:

$$\vert SegMax - SegMax \vert > PV * SegAvg .$$

Where the absolute value of the difference in SegMin and SegMax exceeds a predetermined value multiplied by SegAvg, then the analyzer 1 will indicate to the user a fail status and can further indicate to the user that a cuvette 20 may contain an abnormal reaction condition. In one example, the predetermined value is 5% such that if the absolute value of the difference in SegMin and SegMax exceeds 5% of SegAvg, then the analyzer 1 will present a fail status and notification of a possible abnormal reaction condition in the cuvette 20. In one example, the abnormal reaction condition detected in this manner may comprise bubbles or crystals formed or forming in the cuvette 20. A user at this point would be prompted to check the cuvette before further analysis of samples continues. In some versions the test may be skipped, and an enhanced wash conducted before resuming, or the test may be skipped and the cuvette 20 proceeds to the wash cycle for the next test.

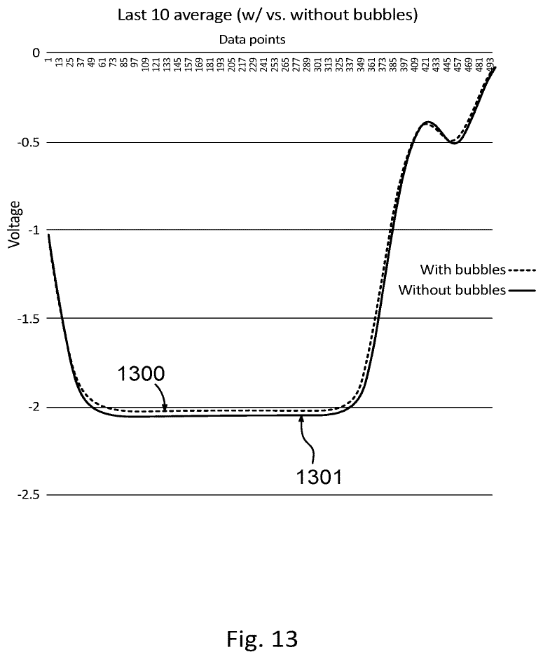

FIG. 13 illustrates an example of a signal recording 1300 showing an instance with detected bubbles during the reaction within the cuvette 20, and a signal recording 1301 without detected bubbles during the reaction within the cuvette 20.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A method for monitoring a condition associated with a cuvette of a plurality of cuvettes used with an automatic analyzer configured to measure an analyte in a sample using a spectrophotometer, comprising:
a. defining a signal recording range of the cuvette by monitoring an incoming signal representing a voltage output derived from a light intensity detected by the spectrophotometer;
b. generating a first baseline signal for each of the cuvettes from incoming signals from multiple wash cycles when the cuvette contains a fluid, the first baseline signal representing an average of multiple data points recorded from multiple segments of the defined signal recording range;
c. evaluating the cuvette condition by performing at least one of the following steps:
i. monitoring a duration of a voltage curve,
ii. comparing the first baseline signal with a first subsequent signal recording generated from the incoming signal during a later wash cycle of the cuvette when the cuvette contains the fluid, the first subsequent signal recording representing multiple data points recorded from multiple segments of the defined signal recording range, and
iii. comparing the first subsequent signal recording with at least some of the multiple data points of the first subsequent signal recording.

2. The method of claim 1, wherein comparing the first subsequent signal recording with the first baseline signal verifies whether the cuvette is present within the automatic analyzer.

3. The method of claim 2, wherein the cuvette is deemed not present if the first subsequent signal recording is greater than a predetermined value of the first baseline signal.

4. (canceled)

5. The method of claim 1, wherein monitoring the duration of the voltage curve verifies whether the cuvette matches a desired size.

6. The method of claim 5, wherein the cuvette is deemed to not match the desired size if a time for the incoming signal to cross below a predetermined voltage exceeds a predetermined time.

7. (canceled)

8. The method of claim 1, wherein comparing the first subsequent signal recording with the first baseline signal verifies whether the cuvette contains an abnormality.

9. The method of claim 8, wherein the cuvette is deemed to contain the abnormality if the first subsequent signal recording is greater than or less than a predetermined amount of the first baseline signal.

10. (canceled)

11. The method of claim 1, wherein comparing the first subsequent signal recording with the at least some of the multiple data points of the first subsequent signal recording verifies whether the cuvette contains an abnormality.

12. The method of claim 11, wherein the cuvette is deemed to contain an abnormality if the first subsequent signal recording has |SegMin−SegMax|>a predetermined value of SegAvg, where SegMin is the minimum average voltage reading of the segments, SegMax is the maximum average voltage reading of the segments, and SegAvg is the average voltage reading of the segments of the first subsequent signal recording.

13. (canceled)

14. The method of claim 8, wherein the abnormality comprises one or both of a stain on the cuvette and a scar on the cuvette.

15. The method of claim 1, further comprising detecting an abnormal reaction condition.

16. The method of claim 15, further comprising generating a second baseline signal during a reagent fill cycle when the cuvettes contain a reagent without a sample, the second baseline signal representing an average of the incoming signal for the cuvette containing the reagent without the sample.

17. The method of claim 16, further comprising generating a second subsequent signal recording representing the incoming signal for the cuvette containing the reagent without the sample during a later reagent fill cycle of the cuvette, the second subsequent signal recording representing multiple data points recorded from multiple segments across the defined signal recording range.

18. The method of claim 16, wherein the cuvette is deemed to have the abnormal condition if the second subsequent signal recording is greater than or less than a predetermined value of the first baseline signal multiplied by an assay factor multiplied by the second baseline signal.

19. (canceled)

20. The method of claim 16, wherein the cuvette is deemed to have the abnormal condition if the second subsequent signal recording has |SegMin−SegMax|>a predetermined value of SegAvg, where SegMin is the minimum average voltage reading of the segments, SegMax is the maximum average voltage reading of the segments, and SegAvg is the average voltage reading of the segments for the second subsequent signal recording.

21. (canceled)

22. The method of claim 15, wherein detecting the abnormal reaction condition includes detecting one or more of bubbles and crystals after the reagent addition to the cuvette.

23-26. (canceled)

27. The method of claim 1, wherein generating the first baseline signal includes storing an average of the multiple data points by each segment for multiple cuvettes to generate a matrix of the incoming signal by cuvette and segment.

28. The method of claim 1, further comprising applying a signal recording rule to the defined signal recording range, wherein the signal recording rule defines a total number of the multiple data points and a total number of the multiple segments from which the multiple data points are recorded.

29. The method of claim 28, wherein data point recording is triggered by the voltage achieving a specified condition according to the signal recording rule.

30-34. (canceled)

35. A system for monitoring a condition associated with a cuvette, the system comprising an automatic analyzer configured to measure an analyte in a sample using a spectrophotometer, the cuvette, and a fluid selectively contained within the cuvette, the system configured to:
a. define a signal recording range of the cuvette by monitoring an incoming signal representing a voltage output derived from a light intensity detected by the spectrophotometer;
b. generate a first baseline signal for the cuvette from incoming signals taken in accordance with the signal recording range from multiple wash cycles when the cuvette contains a fluid, the first baseline signal being continuously updated from multiple wash cycles of the cuvette;
c. evaluate the cuvette condition by performing at least one of the following steps:
i. monitor a duration of a voltage curve,
ii. compare the first baseline signal with a first subsequent signal recording generated from the incoming signal during a later wash cycle of the cuvette when the cuvette contains the fluid, and
iii. comparing the first subsequent signal recording with at least a portion of the data of the first subsequent signal recording.
